(19) United States
(12) Patent Application Publication
(10) Pub. No.: US 2007/0087444 A1
(43) Pub. Date: Apr. 19, 2007

(54) Adsorbent composition with reactive indicator

(76) Inventor: William G. England, Suwanee, GA (US)

Correspondence Address: JOHN S. PRATT, ESQ;KILPATRICK STOCKTON, LLP, 1100 PEACHTREE STREET, ATLANTA, GA, 30309, US

(21) Appl. No.: 11/581,772

(22) Filed: Oct. 16, 2006

Related U.S. Application Data
(60) Provisional application No. 60/726,724, filed on Oct. 14, 2005.

(51) Int. Cl. G01N 21/75

(52) U.S. Cl. 436/166

(57) ABSTRACT

A composition and method of determining the remaining service life in an impregnated adsorbent composition. Composition is an indicating absorbent composition that contains both an impregnated adsorbent component and a reactive indicator. The indicating absorbent composition is used for air purification in the same manner that any impregnated adsorbent filtration medium is used, except that it contains an internal means for determining its remaining service life. The reactive indicator is designed to undergo a color change or loss of color intensity upon contact with noxious or hazardous contaminants, wherein the indicating absorbent composition removes contaminants from a contaminated air stream, thereby affording an optical means of determining the indicating absorbent composition remaining service life. In one embodiment, the color change is in the visible spectrum, such that a simple calorimetric comparison of the reactive indicator and a standardized or calibrated color chart is used to ascertain the remaining service life of the indicating absorbent composition.

### CROSS REFERENCE TO RELATED APPLICATIONS

This application claims the benefit of U.S. Provisional Application No. 60/726,724, filed Oct. 14, 2005, which is incorporated herein by reference.

### FIELD OF THE INVENTION

This relates generally to the field of air purification and air quality monitoring. More particularly, this relates to solid adsorption compositions, methods for purifying air and monitoring air quality, and methods of testing for remaining life of solid adsorption compositions.

### BACKGROUND OF THE INVENTION

Each year numerous incidents are reported worldwide in which noxious fumes or toxic chemicals are released, causing serious injury or illness to those exposed. Adsorbents have been used extensively for protection against such incidents to remove toxic gases, airborne compounds and vapors from breathing air, and many current air purification systems incorporate adsorbents as a major component. One such adsorbent, activated carbon, is a highly porous form of charcoal that has been treated by selective oxidation so as to readily adsorb large quantities of gases, volatile compounds, and other undesirable impurities from fluid streams. While activated carbon is effective at adsorbing relatively large, low vapor pressure molecules in its pores, it is far less effective at removing volatile, high vapor pressure organic compounds. Therefore, for superior air purification performance, activated carbon is often treated with impregnates capable of reacting with and removing gases that would not otherwise be removed by activated carbon alone.

Many formulations of impregnated activated carbon are known, and many contain metal compounds as reactive impregnates, particularly oxides or salts of the transition metals. For example, copper or potassium hydroxide impregnates are effective to remove chlorine, hydrogen chloride, and hydrogen sulfide, while phosphine and arsine are removed by copper and silver impregnates. Specific references that describe metal impregnates for activated carbon include the following patents. Copper, chromium, silver and molybdenum impregnates are described in U.S. Pat. No. 2,920,050 to Blacet et. al. U.S. Pat. No. 2,920,051 to Morse et. al. also discloses copper, chromium, silver and molybdenum impregnates of activated carbon. Doughty et al. describes the use of copper, zinc, triethylenediamine, and other impregnates in U.S. Pat. No. 5,063,196. Groose describes activated carbon impregnated with mixtures of copper, silver and/or chromium, and triethylenediamine in U.S. Pat. No. 4,531,953. The entire text and the references and patents mentioned herein are hereby incorporated by reference in their entirety.

The service life of an impregnated adsorbent filter system is a function of both the adsorbent portion and the impregnate portion of the impregnated adsorbent composition. The service life is clearly influenced by numerous factors including, but not limited to, the air quality that passes through it, and additional factors such as humidity, temperature variations, and the nature of the byproducts that arise from chemical absorption and reaction processes of the impregnate. Therefore, the useful service life of an impregnated adsorbent composition is difficult to predict or accurately determine. Accordingly, a method for readily determining the remaining life of an impregnated absorbent composition that acts as a filter would represent a huge advancement in air purification technology.

Current practice in areas that employ impregnated adsorbent filters to filter the air within an enclosed area is to routinely replace the entire filter bed annually, in an effort to maintain filter viability. This approach suffers from several drawbacks. First, no qualitative determination is made of whether there is any remaining life of the filter at the time of replacement. Although filters are replaced according to time in service using conservative estimates, it is conceivable that these filters may have already expired before their set service time. Second, no quantitative determination of remaining filter life is made, therefore it is also possible—even likely—that filters are being replaced long before their useable life has expired. In this case, a program of annual replacement of the entire filter results in a considerable and unnecessary expense.

Therefore, a major concern with using an impregnated adsorption filter in critical control areas is determining the remaining service life of the filter. What is needed is a method of determining if there is any remaining life in an impregnated adsorbent filter, and if so, a means of determining approximately how much life remains. Such a method or test should be versatile enough for use in any installation, regardless of the identity, concentration, and exposure time of the contaminants.

### SUMMARY OF THE INVENTION

Compositions and methods for quickly and accurately determining the remaining life of an impregnated adsorbent filter are provided herein. Practicing this method requires no complex equipment or special expertise, and uses inexpensive and readily available components. The method is easily be performed under any field conditions, and is performed for example, by direct visualization of the impregnated adsorbent composition of the filter, thereby avoiding the need to sample the filtration medium itself, or the need for expensive or complex testing equipment that would need to be installed and used along with the impregnated adsorbent filter. In addition, the method can provide an immediate quantitative prediction of the remaining life of the filter.

To achieve the above and other objectives, a unique solid filtration medium is provided, referred to herein as an indicating adsorbent composition, that contains an adsorbent material, an impregnate, and a reactive indicator. In one embodiment, the reactive indicator is a water soluble pH indicator. The reactive indicator allows one to determine the remaining service life of the indicating adsorbent composition. The indicating adsorbent filter may be used for air purification in the same manner that any impregnated adsorbent filtration medium is used, except that it includes an internal means for determining the remaining life of the filter.

The impregnated adsorbent component of the indicating adsorbent composition is typically activated carbon, alumina, calcium hydroxide, zeolite, or a combination thereof that has been impregnated with a material that is reactive toward noxious, airborne compounds and hazardous contaminants. The reactive impregnate material may be an oxidant or reductant, acid, base, or salt. Typical impregnates include transition metals, main group metals, metal salts, metal compounds, various acids or acid salts, bases or base salts, or combinations of the above. In one embodiment, the impregnate reacts by neutralizing opposing acids or bases.

One effective type of impregnated adsorbent that can be used in the composition provided herein is described in U.S. Pat. No. 5,492,882, assigned to Calgon Carbon Corporation (Pittsburgh, Pa.). A preferred embodiment of the Calgon impregnated carbon starts with a coal-base granular activated carbon adsorbent, or similar porous media. The carbon adsorbent is then impregnated to provide as a final composition containing (by weight percent) up to 20% or more zinc (as ZnCO₃, ZnSO₄, ZnO or ZnMoO₄ equivalents), up to 20% or more copper (as CuCO₃, CuSO₄, CuO or CuMoO₄ equivalents), up to 10% or more SO₄²⁻ (directly or as copper or zinc sulfate), up to 10% or more molybdenum (as [Mo₂O₇]²⁻ or MoO₄²⁻ equivalents) and up to 25% water. Further, triethylenediamine (TEDA) can be added to provide cyanogen chloride protection. There is considerable variation in these weight percent ranges, depending upon the particular application or performance characteristics desired in the final composition as known to one of ordinary skill in the art.

Another example of an impregnated adsorbent that can be used in the composition is described in U.S. Pat. No. 4,855,276, which discloses an activated carbon/alumina/sodium bicarbonate based adsorbent. The adsorbent is then impregnated to provide a final composition containing (by weight percent) a combination of KOH and KI up to 1% to 10% of each compound. There is considerable variation in these weight percent ranges, depending upon the particular application or performance characteristics desired in the final composition as known to one of ordinary skill in the art.

In one embodiment, the reactive indicator of the indicating adsorbent composition is a pH indicator that changes color or color intensity, in the visible region of the electromagnetic spectrum. For example, the pH indicator changes color or color intensity in the visible region of the electromagnetic spectrum upon neutralization of an opposing acid or base. Preferably, the color change is visibly detectable on or within the filter. In one embodiment, the color change is compared to a pH standard calibrated to show the remaining service life of the filter. For example, the indicating adsorbent composition is quantitatively compared against a colorimetric standard chart. By determining the pH of the filter by a visible color change, a direct indication of the remaining service life of the indicating adsorbent composition, and thus the remaining service life of filter, is quickly and easily obtained. In a preferred embodiment, the pH indicator of the indicating adsorbent composition is water-soluble. In a preferred indicating adsorbent composition, the reactive indicator is Bromothymol blue. Alternatively, the water-soluble pH indicator is Alizarin sodium sulfonate, Alizarin yellow, a-Naphtholbenzein, a-Naphthyl red, a-Naphtolphthalein, Azolitmin, Bromcresol green, Bromcresol purple, Bromophenol blue, Bromophenol red, Chlorphenol red, Cresol red, Diazo violet, Methyl orange, Methyl red, Neutral red, Nile blue, Nitramine, Pentamethoxy red, p-Ethoxychrysoidine, Phenol red, Phenolphthalein, p-Nitrophenol, Poirrier's blue, Rosolic acid, Salicyl yellow, Tetrabromphenol blue, Thymol blue, Thymolphthalein, Trinitrobenzoic acid, Tropeolin O, Tropeolin OO, Tropeolin OOO, 2-nitrophenol, 3-nitrophenol, Alizarin-3-mthyliminodiacetic acid, Alizarin red, Benzyl orange, Bromochlorophenol blue, Bromothymol blue, Bromoxylenol blue, Congo red, Curcumin, Dimethyl yellow, m-Cresol purple, o-Cresolphthalein, Phenol violet, Quinaldine red, Thymol violet, Brilliant yellow, Ethyl orange, p-Xylenol, Metanil yellow, 2,5-dinitrophenol, 4-nitrophenol or the like.

Accordingly, it is an object of the invention to provide an indicating adsorbent composition for removing noxious or hazardous contaminants from air wherein the composition includes a reactive indicator component that provides a simple means for determining the remaining service life of the indicating adsorbent composition.

It is another object of the present invention to provide a quick method of determining the remaining service life of an indicating adsorbent composition used for air purification or filtration.

Still another object of the present invention is to provide a kit for the rapid and inexpensive determination of the remaining service life of an air purification filter.

Another object of the present invention is to provide a method to determine the remaining service life of an indicating adsorbent composition that requires no special expertise or instrumentation to use, requires only inexpensive testing components, and provides an immediate determination of the remaining service life of the composition.

Still another object of this invention is to provide a test to determine the viability or remaining service life of an indicating adsorbent composition that can be carried out by visually inspecting the filtration medium itself, rather than sampling the filtration medium or using complex testing or sampling equipment.

Another objective of the instant application is to provide an in-situ method to determine the service life of an air filter by including a reactive indicator in the adsorbent composition, wherein the indicating adsorbent composition contains a reactive indicator, wherein the reactive indicator predicts the remaining service life of the adsorbent composition and, therefore, the filter.

These and other objects, features, and advantages of the present invention may be more clearly appreciated from a review of the following detailed description of the disclosed embodiments and by reference to the appended examples and claims.

### DETAILED DESCRIPTION OF THE INVENTION

An indicating adsorbent composition for air purification, methods of purifying an air stream using the indicating adsorbent composition, and methods of determining the viability or remaining life of the indicating adsorbent composition are described herein. The indicating adsorbent composition is a mixture of an impregnate, an adsorbent component that removes chemical agents from an air stream, and a reactive indicator. Preferably the reactive indicator undergoes a color change or loss of color intensity as chemical agents, toxic or hazardous contaminants are neutralized.

In one embodiment, the reactive indicator undergoes a color change or loss of color intensity in the visible spectrum. In another embodiment, the reactive indicator is a pH indicator. In a further embodiment, the reactive indicator is a water-soluble pH indicator such as, but not limited to, Alizarin sodium sulfonate, Alizarin yellow, a-Naphtholbenzein, a-Naphthyl red, a-Naphtolphthalein, Azolitmin, Bromcresol green, Bromcresol purple, Bromophenol blue, Bromophenol red, Chlorphenol red, Cresol red, Diazo violet, Methyl orange, Methyl red, Neutral red, Nile blue, Nitramine, Pentamethoxy red, p-Ethoxychrysoidine, Phenol red, Phenolphthalein, p-Nitrophenol, Poirrier's blue, Rosolic acid, Salicyl yellow, Tetrabromphenol blue, Thymol blue, Thymolphthalein, Trinitrobenzoic acid, Tropeoplin O, Tropeoplin OO, Tropeoplin OOO, 2-Nitrophenol, 3-Nitrophenol, Alizarin-3-mthyliminodiacetic acid, Alizarin red, Benzyl orange, Bromochlorophenol blue, Bromothymol blue, Bromoxylenol blue, Congo red, Curcumin, Dimethyl yellow, m-Cresol purple, o-Cresolphthalein, Phenol violet, Quinaldine red, Thymol violet, Brilliant yellow, Ethyl orange, p-Xylenol, Metanil yellow, 2,5-dinitrophenol, 4-nitrophenol or other water-soluble pH indicators known to one of ordinary skill in the art. A preferred reactive indicator is Bromothymol blue.

By periodically visually inspecting the indicating adsorbent composition itself, and comparing the color change of the reactive indicator, for example, against a standardized colorimetric chart, the remaining life of the indicating adsorbent composition can be easily determined. In a preferred embodiment, the color change is in the visible region, therefore a simple colorimetric comparison of the reactive indicator as a component of the indicating adsorbent composition and a color standard is used to ascertain the remaining service life of the indicating adsorbent composition, thereby determining if the indicating adsorbent composition, in the form of a filter, maintains the ability to neutralize and remove chemical agents from an air stream or should be replaced.

Definitions

In order to more fully describe the various aspects of the indicating adsorbent composition and methods for use, the following definitions are provided.

The term “adsorbent”, and related terms such as adsorbent component, are used herein to refer to the component of the indicating adsorbent composition containing a solid porous filtration media. Typically, the adsorbent component contains activated carbon, alumina, calcium hydroxide, zeolite, or similar porous media. The adsorbent can also be any combination thereof.

The term “impregnate”, and related terms such as impregnate component, reactive impregnate, reactive agent, and the like, are used herein to refer to a material that is reactive toward noxious, airborne compounds and hazardous contaminants. The impregnates can be, but are not limited to, metals, metal salts, metal compounds, acids, acid salts, bases, base salts, and the like so as to react with noxious, toxic and hazardous chemical contaminants. Preferably, the adsorbent is impregnated with one or more acids, acid salts, bases and base salts.

The term “impregnated adsorbent component” and related terms such as impregnated adsorbent, impregnated adsorbent composition, impregnated adsorbent filter, impregnated filtration media, impregnated filtration medium and the like, are used herein to refer to the component of the indicating adsorbent composition that constitutes or contains an adsorbent that is impregnated with various reactive agents. Upon contacting the fluid stream, typically, an air stream, with the impregnated adsorbent component, both the adsorbent portion and the impregnate portion of the indicating adsorbent composition effect the removal of contaminants from the fluid stream.

The term “reactive indicator” and related terms such as reactive indicator component, indicator component, active indicator, indicator, and the like, are used herein to refer to the reactive indicator of the indicating adsorbent composition that undergoes a color change or a change in color intensity. In one embodiment, the reactive indicator undergoes a color change or a change in color intensity in the visible region of the electromagnetic spectrum, upon capture, removal or neutralization of undesirable contaminants. Typically, the reactive indicator will constitute or contain a water-soluble substance. In a preferred embodiment, the reactive indicator contains a pH indicator. In another embodiment, neutralization of contaminants results in a change in color or color intensity of the reactive indicator. The reactive indicator component may be considered “indicating” in that its reaction to a change in pH results in a color change indicating a change in the pH of the impregnated absorbent composition. For example, the greater the extent of neutralization of chemical contaminants, the greater the color change, and less service life remaining in the indicating adsorbent composition. The reactive indicator upon exposure and neutralization of chemical agents will provide either a more intensely colored, or a less intensely colored composition upon a change in pH. The color change is therefore correlated with the remaining ability of the indicating adsorbent composition to neutralize or remove contaminants, and hence, the indicating adsorbent composition's remaining service life. A single reactive indicator can be combined with other suitable reactive indicators in the indicating adsorption composition to effect indication over a more defined range of pH.

The term “indicating adsorbent composition” and related terms such as indicating composition, indicating adsorbent component, indicating adsorbent filter, indicating adsorbent filter media and the like, are used herein to denote the combination of an impregnated adsorbent component and a reactive indicator in a medium. The term is used regardless of the relative proportions of each component, the particle sizes of each component, or their specific chemical composition. Moreover, the term “indicating adsorbent composition” is used to describe a composition containing one or more impregnated adsorbent components and/or more than one reactive indicators.

The term “color chart” is used to mean, without limitation, any type of color intensity comparison means for determining the relative pH of the reactive indicator component. Thus, a color chart is a spectral standard that indicates the progression of colors, intensity or tints reflecting the change in pH of the reactive indicator upon exposure to airborne compounds or for example contaminants. A color chart may be a printed device with colored portions of different color or intensity, reflecting a change in pH of the indicating adsorbent composition. Indeed, a color chart may be a pH standard of any type which, when compared directly with the indicating adsorbent composition, provides a measurement of the pH of the reactive indicator in a manner known to one of ordinary skill in the art.

Selection of Components of the Indicating Adsorbent Composition

The impregnated adsorbent component of the indicating adsorbent composition contains activated carbon, alumina, calcium hydroxide, zeolite, or similar porous media, or a combination thereof, impregnated with one or more materials that are reactive toward noxious, hazardous or airborne contaminants. The reactive material may be an oxidant or reductant, acid, base, or salt. The reactive material is preferably an impregnate. Typical impregnates include transition metals, main group metals, metal salts, metal compounds, various acids or acid salts, bases or base salts, or combinations of the above. In one embodiment, the impregnate is capable of neutralizing an opposing chemical compound. For example, while not wishing to be bound by the following, it is contemplated that a basic impregnate can neutralize an acidic contaminant. Similarly, it is contemplated that an acidic impregnate can neutralize basic contaminants. Preferred impregnates include potassium hydroxide, sodium hydroxide, calcium hydroxide, magnesium hydroxide, phosphoric acid, sulfuric acid, and nitric acid.

Both the adsorbent component and the impregnate component of the indicating adsorbent composition operate to remove contaminants and purify a fluid stream, and typically these portions operate by different processes. Adsorbents, with their varying pore sizes and very large surface areas, are effective at physically adsorbing or trapping molecules of a substance on its surface. The effectiveness of adsorbents extends primarily to adsorbing larger molecules of relatively low vapor pressure, typically around 10 mm Hg and less at the ambient temperature. The impregnate component of the indicating adsorbent composition typically removes contaminants by chemical reaction to convert them to non-volatile or less volatile species that are innocuous or more readily adsorbed. Thus, the chemical absorption/reaction process of the impregnate differs from, and complements, the physical adsorption process of the adsorbent to remove a range of hazardous, noxious and airborne compounds from the air stream.

In one embodiment, the reactive indicator is selected such that it will undergo a color change or a loss of color intensity in the visible region of the electromagnetic spectrum as the impregnated adsorbent component reacts with and neutralizes contaminants in the airstream. In this way, the reactive indicator affords a visual means of determining the remaining lifetime of the indicating adsorbent composition. In one embodiment, the reactive indicator contains Alizarin sodium sulfonate, Alizarin yellow, a-Naphtholbenzein, a-Naphthyl red, a-Naphtolphthalein, Azolitmin, Bromcresol green, Bromcresol purple, Bromophenol blue, Bromophenol red, Chlorphenol red, Cresol red, Diazo violet, Methyl orange, Methyl red, Methyl yellow, Methyl blue, Methyl orange, Neutral red, Nile blue, Nitramine, Pentamethoxy red, p-Ethoxychrysoidine, Phenol red, Phenolphthalein, p-Nitrophenol, Poirrier's blue, Rosolic acid, Salicyl yellow, Tetrabromphenol blue, Thymol blue, Thymolphthalein, Trinitrobenzoic acid, Tropeoplin O, Tropeoplin OO, Tropeoplin OOO, 2-nitrophenol, 3-nitrophenol, Alizarin-3-mthyliminodiacetic acid, Alizarin red, Benzyl orange, Bromochlorophenol blue, Bromothymol blue, Bromoxylenol blue, Congo red, Curcumin, Dimethyl yellow, m-Cresol purple, o-Cresolphthalein, Phenol violet, Quinaldine red, Thymol violet, Brilliant yellow, Ethyl orange, p-Xylenol, Metanil yellow, 2,5-dinitrophenol, 4-nitrophenol or other water soluble pH indicators known to one of ordinary skill in the art. A preferred reactive indicator is Bromothymol blue.

The reactive indicator component directly correlates with the remaining ability of the indicating adsorbent composition to neutralize or remove contaminants. Upon exposure to contaminants, the reactive indicator will change color. Upon observation of a complete color change, this point will accurately indicate that the indicating adsorbent composition has no remaining service life. To safely operate the filter, the indicating adsorbent composition should be changed when the indicator has completely changed color. In the case of comparable consumption rates, a colorimetric test can be used to provide quantitative data. For example, a colorimetric measurement that the reactive indicator is 40% consumed accurately reflects that the indicating adsorbent composition is also 40% consumed.

The consumption rates of the reactive indicator are determined by, but not limited to, many factors. These factors include the absolute capacity (e.g. by weight) at which each component can adsorb or absorb a toxic gas; the concentration or “loading” of the reactive ingredient in each component particle; the stoichiometry or mass balance of the particular chemical reaction(s) that results in absorption; the chemical kinetics of the absorption reaction(s); the kinetics at which a gas or airborne compound can permeate the pores of a particle or the outer layers of active ingredient that have previously been reacted; and so forth. Because the factors and their interrelations are complex, a reliable correlation between the service life remaining of the reactive indicator and the life remaining in the indicating adsorbent composition is best made by empirical measurements.

A potentially dangerous situation exists if the reactive indicator is neutralized at a slower rate than the indicating adsorbent composition. In this instance, the reactive indicator has some remaining life and may not therefore accurately indicate that the indicating adsorbent composition has expired. Therefore, in this instance any indication of remaining life of the reactive indicator cannot be used to accurately judge the efficacy of the indicating adsorbent composition.

Preparation of the Indicating Adsorbent Composition

To prepare the indicating adsorbent composition of this invention, a mixture of the impregnated adsorbent component and a reactive indicator is prepared. These components should be thoroughly commingled so as to provide a mixture that avoids local concentrations of either individual component. Any means of thorough mixing these components may be used, such as tumbling, rolling, extruding and the like. It is preferable that the sizes of the solid particles of the individual components be substantially similar to avoid physical settling of any one component. Thus any physical settling, lack of proper mixing, or other process which might result in local concentration extremes of either component will reduce the accuracy of the monitoring test, and hence the ability to determine remaining service life.

The indicating adsorbent composition of this invention is operative over a range of weight or volume percentages of the two components of this mixture, although the impregnated adsorbent component is typically present in greater proportion. In one embodiment, the reactive indicator is present from about 2-25 weight percent, while the impregnated adsorbent component is present from about 75-98 weight percent. In another embodiment, the reactive indicator is present from about 1-2 weight percent, while the impregnated adsorbent component is present from about 98-99 weight percent. In yet another embodiment, the reactive indicator is present from about 0.1-1 weight percent, while the impregnated adsorbent component is present from about 99-99.9 weight percent.

The indicating adsorbent composition of the present invention is also operative using different particle sizes of mixture components. However, for a more accurate determination of remaining service life, it is preferable that the particle size range be relatively narrow, and that the particles sizes of the individual components be substantially similar, to avoid physical settling of any one component. For example, in one embodiment, the adsorbent material and the impregnate component are about 3×20 mesh in size. In another embodiment, the adsorbent component and the impregnate component are about 4×8 mesh in size. In yet another embodiment, the adsorbent material and the impregnate component are 4×6 mesh in size. Preferably, the range in mesh size for the adsorbent and impregnate components is over a 2 mesh range, as exemplified by the 4×6 mesh sample.

Using the Indicating Adsorbent Composition

The indicating adsorbent composition described herein is used in the same manner as any impregnated adsorbent, whether in an air filtration device for protecting an entire building, in a personal respirator, or in other equivalent applications. It is preferable that the particular filtration device containing the indicating adsorbent composition include some means for visually inspecting the composition, because the test for remaining service life is carried out by viewing the indicating adsorbent composition itself.

In one example, to determine the remaining service life of the indicating adsorbent composition, the color of the reactive indicator is compared to a color chart, wherein the colors are matched to indicate the pH of the indicating adsorbent composition. Accordingly, the pH measurement indicates the remaining service life of the indicating adsorbent composition because the color reflects the pH of the impregnated adsorbent component and therefore its remaining ability to capture, neutralize or remove contaminants.

In another embodiment, the color chart constitutes a printed device containing colored portions of varying intensities, reflecting differing pHs of the reactive indicator. In yet another embodiment, a color chart is a pH standard of any type which, when compared to the color of the indicating adsorbent composition, provides a measurement of the pH of the indicating adsorbent composition.

For example, in one embodiment, Alizarin sodium sulfonate is used as the reactive indictor. Typically, Alizarin sodium sulfonate will be yellow in acidic conditions and violet in basic conditions. In a preferred embodiment, Alizarin sodium sulfonate has a optimal pH range of about 3.7 to about 5.2.

In another embodiment, Alizarin yellow is used as the reactive indictor. Typically, Alizarin yellow will be yellow in acidic conditions and lilac in basic conditions. In a preferred embodiment, Alizarin yellow has a optimal pH range of about 10 to about 12.

In another embodiment, Thymol blue is used as the reactive indictor. Typically, Thymol blue will be red in acidic conditions and yellow in basic conditions. In a preferred embodiment, Thymol blue has a optimal pH range of about 1.2 to about 2.8.

In yet another embodiment, pentamethoxy red is used as the reactive indictor. Typically, pentamethoxy red will be red-violet in acidic conditions and colorless in basic conditions. In a preferred embodiment, pentamethoxy red has a optimal pH range of about 1.2 to about 2.3.

In another embodiment, Tropeoplin OO is used as the reactive indictor. Typically, Tropeolin OO will be red in acidic conditions and yellow in basic conditions. In a preferred embodiment, Tropeolin OO has a optimal pH range of about 1.3 to about 3.2.

In another embodiment, 2,4-Dinitrophenol is used as the reactive indictor. Typically, 2,4-Dinitrophenol will be colorless in acidic conditions and yellow in basic conditions. In a preferred embodiment, 2,4-Dinitrophenol has a optimal pH range of about 2.4 to about 4.0.

In yet another embodiment, methyl yellow is used as the reactive indictor. Typically, methyl yellow will be red in acidic conditions and yellow in basic conditions. In a preferred embodiment, methyl yellow has a optimal pH range of about 2.9 to about 4.0.

In another embodiment, methyl orange is used as the reactive indictor. Typically, methyl orange will be red in acidic conditions and orange in basic conditions. In a preferred embodiment, methyl orange has a optimal pH range of about 3.1 to about 4.4.

In another embodiment, tetrabromphenol blue may be used as the reactive indictor. Typically, tetrabromphenol blue will be yellow in acidic conditions and blue in basic conditions. In a preferred embodiment, tetrabromphenol blue has a optimal pH range of about 3.0 to about 4.6.

In yet another embodiment, Bromophenol blue is used as the reactive indicator. Typically, Bromophenol blue will be blue-violet in basic conditions and yellow in acidic conditions. In a preferred embodiment, Bromophenol blue has an optimal pH range of about 3.0 to about 4.6.

In another embodiment, a-Naphthyl red is used as the reactive indictor. Typically, a-Naphthyl red will be red in acidic conditions and yellow in basic conditions. In a preferred embodiment, a-Naphthyl red has a optimal pH range of about 3.7 to about 5.0.

In yet another embodiment, p-Ethoxychrysoidine is used as reactive indictor. Typically, p-Ethoxychrysoidine will be red in acidic conditions and yellow in basic conditions. In a preferred embodiment, p-Ethoxychrysoidine has a optimal pH range of about 3.5 to about 5.5.

In another embodiment, Bromcresol green is used as the reactive indictor. Typically, Bromcresol green will be yellow in acidic conditions and blue in basic conditions. In a preferred embodiment, Bromcresol green has a optimal pH range of about 4.0 to about 5.6.

In one embodiment, methyl red is used as the reactive indictor. Typically, methyl red will be red in acidic conditions and yellow in basic conditions. In a preferred embodiment, methyl orange has a optimal pH range of about 4.4 to about 6.2.

In another embodiment, Bromcresol purple is used as the reactive indictor. Typically, Bromcresol purple will be yellow in acidic conditions and purple in basic conditions. In a preferred embodiment, Bromcresol purple has a optimal pH range of about 5.2 to about 6.8.

In another embodiment, Chlorphenol red is used as the reactive indictor. Typically, Chlorphenol red will be yellow in acidic conditions and red in basic conditions. In a preferred embodiment, Chlorphenol red has a optimal pH range of about 5.4 to about 6.8.

In yet another embodiment, p-Nitrophenol is used as the reactive indictor. Typically, p-Nitrophenol will be colorless in acidic conditions and yellow in basic conditions. In a preferred embodiment, p-Nitrophenol has a optimal pH range of about 5.0 to about 7.0.

In another embodiment, Azolitmin is used as the reactive indictor. Typically, Azolitmin will be red in acidic conditions and blue in basic conditions. In a preferred embodiment, Azolitmin has a optimal pH range of about 5.0 to about 8.0.

In another embodiment, phenol red is used as the reactive indictor. Typically, phenol red will be yellow in acidic conditions and red in basic conditions. In a preferred embodiment, phenol red has a optimal pH range of about 6.4 to about 8.0.

In one embodiment, neutral red is used as the reactive indictor. Typically, neutral red will be red in acidic conditions and yellow in basic conditions. In a preferred embodiment, neutral red has a optimal pH range of about 6.8 to about 8.0.

In one embodiment, rosolic acid is used as the reactive indictor. Typically, rosolic acid will be yellow in acidic conditions and red in basic conditions. In a preferred embodiment, rosolic acid has a optimal pH range of about 6.8 to about 8.0.

In another embodiment, cresol red is used as the reactive indictor. Typically, cresol red will be yellow in acidic conditions and red in basic conditions. In a preferred embodiment, cresol red has a optimal pH range of about 7.2 to about 8.8.

In one embodiment, a-naphtholphthalein is used as the reactive indictor. Typically, a-naphtholphthalein will be rose in acidic conditions and green in basic conditions. In a preferred embodiment, a-naphtholphthalein has a optimal pH range of about 7.3 to about 8.7.

In yet another embodiment, Tropeolin OOO is used as the reactive indictor. Typically, Tropeolin OOO will be yellow in acidic conditions and rose-red in basic conditions. In a preferred embodiment, Tropeolin OOO has a optimal pH range of about 7.6 to about 8.9.

In one embodiment, phenolphthalein is used as the reactive indictor. Typically, phenolphthalein will be colorless in acidic conditions and red in basic conditions. In a preferred embodiment, phenolphthalein has a optimal pH range of about 8.0 to about 10.0.

In another embodiment, a-naphtholbenzein is used as the reactive indictor. Typically, a-naphtholbenzein will be yellow in acidic conditions and blue in basic conditions. In a preferred embodiment, a-naphtholbenzein has a optimal pH range of about 9.0 to about 11.0.

In yet another embodiment, thymolphthalein is used as the reactive indictor. Typically, thymolphthalein will be colorless in acidic conditions and blue in basic conditions. In a preferred embodiment, thymolphthalein has a optimal pH range of about 9.4 to about 10.6.

In one embodiment, nile blue is used as the reactive indictor. Typically, nile blue will be blue in acidic conditions and red in basic conditions. In a preferred embodiment, nile blue has a optimal pH range of about 10.1 to about 11.1.

In another embodiment, salicyl yellow is used as the reactive indictor. Typically, salicyl yellow will be yellow in acidic conditions and orange-brown in basic conditions. In a preferred embodiment, salicyl yellow has a optimal pH range of about 10.0 to about 12.0.

In one embodiment, diazo violet is used as the reactive indictor. Typically, diazo violet will be yellow in acidic conditions and violet in basic conditions. In a preferred embodiment, diazo violet has a optimal pH range of about 10.1 to about 12.0.

In yet another embodiment, Tropeolin O is used as the reactive indictor. Typically, Tropeolin O will be yellow in acidic conditions and orange-brown in basic conditions. In a preferred embodiment, Tropeolin O has a optimal pH range of about 11.0 to about 13.0.

In one embodiment, Poirrier's blue is used as the reactive indictor. Typically, Poirrier's blue will be blue in acidic conditions and violet-pink in basic conditions. In a preferred embodiment, Poirrier's blue has a optimal pH range of about 11.0 to about 13.0.

In another embodiment, trinitrobenzoic acid is used as the reactive indictor. Typically, trinitrobenzoic acid will be colorless in acidic conditions and orange-red in basic conditions. In a preferred embodiment, trinitrobenzoic acid has a optimal pH range of about 12.0 to about 13.4.

The indicating adsorbent composition described herein can be used alone or in combination with other types of filter and purification devices. In one embodiment, the indicating adsorbent composition is used in conjunction with a High Efficiency Particulate Air (HEPA) filter. HEPA filters are standard components of air filtration systems in military and nuclear industry applications, where they effectively remove biological agents, solid particulates, aerosols, liquid aerosols and similar materials. By incorporating a HEPA filter upstream of the indicating adsorbent composition of the present invention, an additional layer of protection is afforded the occupants of an area to be protected. In addition, in this instance the indicating adsorption composition itself is protected from particulates such as atmospheric dust particles which would otherwise reduce its useful service life. Thus, the indicating adsorbent composition may be used in conjunction with a HEPA filter in the same way that a standard impregnated adsorbent filter would be used.

The following examples will serve to illustrate the indicating adsorbent composition and the monitoring and treatment methods of the present invention.

### EXAMPLE 1

### Preparation of an Indicating Carbon-Based Absorbent Material Using NATO Inpregnated Activated Carbon

An indicating carbon-based absorbent material of the present invention was prepared using a NATO impregnated activated carbon as follows. The NATO carbon is an ASC® 6×16 coal based granular activated carbon, with the following shown in Table 1. This NATO carbon is effective in the removal of several toxic gases and odorous fumes, such as acid gases and organic vapors, and as such is especially useful in respirator applications.

TABLE 1
NATO Carbon Specifications

| Test | Minimum | Maximum |
|---|---|---|
| Moisture, wt. % as | — | 2.0 |
| packed | | |
| Hardness No. | 80 | — |
| A.D. g/cc | — | 0.630 |
| Ammonia Life, minutes | 12 | — |
| Silver, wt. % | 0.04 | — |
| Copper, wt. % as Cu | 4.1 | 5.3 |
| Chromium, wt. % as | 2.9 | 4.0 |
| CrO3 | | |

The indicating carbon-based absorbent material was prepared by thoroughly admixing NATO ASC® 6×16 carbon described above, with KMnO₄, in a 90:10 wt % mixture. This composition can be used for removing the same toxic gases and other undesirable fumes and agents as the NATO ASC® 6×16 carbon composition alone.

### EXAMPLE 2

### Preparation of an Indicating Carbon-Based Absorbent Material Using Calgon Impregnated Activated Carbon

An indicating adsorbent composition of the present invention was prepared using the impregnated carbon developed by Calgon Carbon Corporation (Pittsburgh, Pa.), and described in U.S. Pat. No. 5,492,882. The Calgon carbon is manufactured from selected grades of bituminous coal and offers individual and collective protection due to its impregnation with copper, silver, zinc, molybdenum, and TEDA (triethylenediamine). The specifications for this ASZM-TEDA carbon are shown in Table 2.

TABLE 2
Calgon ASZM-TEDA Carbon Specifications

| Test | Minimum | Maximum |
|---|---|---|
| Moisture, wt. %, as | — | 2.5 |
| packed | | |
| Hardness No. | 85 | — |
| Apparent Density, g/ml | — | 0.68 |
| Copper, wt. % | — | 6.0 |
| Silver, wt. % | 0.030 | 0.1 |
| Zinc, wt. % | | 6.0 |
| Molybdenum, wt. % | | 2.5 |
| TEDA, wt. % | | 2.5 |
| Ammonia Life, minutes | 51 | |

This ASZM-TEDA carbon meets U.S. Military specifications and is chrome free, which may be a consideration due to the toxicity of CrO₃. This material was manufactured and tested for the above properties in accordance with Specification MIL-EA-DTL-1704A 22 Jan. 1999.

The indicating carbon-based absorbent material was prepared by thoroughly admixing the Calgon ASZM-TEDA carbon described above, with KMnO₄, for a 90:10 wt % mixture. This composition can be used for removing the same toxic gases and other undesirable fumes and agents as the Calgon ASZM-TEDA carbon alone.

### EXAMPLE 3

### Preparation of an Indicating Carbon-based Composition for Neutralizing and Removing Acidic Contaminants.

An indicating adsorbent composition of the present invention can be prepared by using pellets of alumina, activated carbon, or a combination thereof impregnated with KOH or NaOH. A reactive indicator, bromophenyl blue, is added to a final concentration of 5% weight of the indicating carbon-based adsorbent composition. The moisture content of the composition is approximately 20% water. The color of the indicating carbon-based adsorbent composition is blue over pH ranges 7-10. As the indicating adsorbent composition reacts with acids the reactive indicator will change from blue to white and then to yellow, as the indicating adsorbent composition neutralizes contaminants and eventually becomes acidic. At a pH lower than 2, the indicating adsorbent composition will be red indicating no remaining service life in the indicating adsorbent composition.

### EXAMPLE 4

### Preparation of a Multiple Impregnate Indicating Adsorbent Composition for Neutralizing and Removing Acidic Contaminants

An indicating adsorbent composition of the present invention can be prepared using alumina, and impregnated with calcium hydroxide and calcium sulphate. A reactive indicator, Bromophenol blue, is added to a final concentration of 0.25% weight of the indicating adsorbent composition. The moisture content of the composition is approximately 20% water. The color of the indicating carbon-based adsorbent composition is blue over pH ranges 7-10. As the indicating adsorbent composition reacts with acids the reactive indicator will change from blue to white and then to yellow, as the indicating adsorbent composition neutralizes contaminants and eventually becomes acidic. At a pH lower than 2, the indicating adsorbent composition will be red indicating no remaining service life in the indicating adsorbent composition.

### EXAMPLE 5

### Preparation of Indicating Adsorbent Composition for Neutralizing and Removing Basic Contaminants

An indicating adsorbent composition of the present invention can be prepared using pellets of activated carbon, activated alumina, or a combination thereof impregnated with phosphoric acid. A reactive indicator, bromophenyl blue, is added to a final concentration of 5% weight of the indicating carbon-based adsorbent composition. The moisture content of the composition is approximately 20% water. The color of the indicating adsorbent composition is yellow from pH 2-3. As the indicating adsorbent composition reacts with bases the reactive indicator will change from yellow to white and then to blue, as the indicating adsorbent composition neutralizes contaminants and eventually becomes basic. An indicating adsorbent composition that has changed completely from yellow to blue will indicate a filter with no remaining service life.

It should be understood, of course, that the foregoing relates only to certain embodiments of the present invention and that numerous modifications or alterations may be made therein without departing from the spirit and the scope of the invention. Further, all of the publications or patents mentioned herein are hereby incorporated by reference in their entireties.

What is claimed is:

1. An indicating adsorbent composition for air purification comprising an adsorbent, an impregnate, and a reactive indicator, wherein the reactive indicator is a pH indicator.

2. The indicating adsorbent composition of claim 1, wherein the adsorbent component further comprises activated carbon, alumina, zeolite, or calcium hydroxide.

3. The indicating adsorbent composition of claim 2, wherein the activated carbon is Calgon ASZM-TEDA carbon or NATO ASC® carbon.

4. The indicating adsorbent composition of claim 1, wherein the impregnate further comprises a metal, metal salt, metal compound, acid, acid salt, base, or base salt.

5. The indicating adsorbent composition of claim 1, wherein the impregnate further comprises potassium hydroxide, sodium hydroxide, magnesium hydroxide, phosphoric acid, sulfuric acid, or nitric acid.

6. The indicating adsorbent composition of claim 1, wherein the reactive indicator is a chemical selected from the group consisting of Alizarin sodium sulfonate, Alizarin yellow, a-Naphtholbenzein, a-Naphthyl red, a-Naphtolphthalein, Azolitmin, Bromcresol green, Bromcresol purple, Bromophenol blue, Bromophenol red, Chlorphenol red, Cresol red, Diazo violet, Methyl orange, Methyl red, Neutral red, Nile blue, Nitramine, Pentamethoxy red, p-Ethoxychrysoidine, Phenol red, Phenolphthalein, p-Nitrophenol, Poirrier's blue, Rosolic acid, Salicyl yellow, Tetrabromphenol blue, Thymol blue, Thymolphthalein, Trinitrobenzoic acid, Tropeolin O, Tropeolin OO, Tropeolin OOO, 2-nitrophenol, 3-nitrophenol, Alizarin-3-mthyliminodiacetic acid, Alizarin red, Benzyl orange, Bromochlorophenol blue, Bromothymol blue, Bromoxylenol blue, Congo red, Curcumin, Dimethyl yellow, m-Cresol purple, o-Cresolphthalein, Phenol violet, Quinaldine red, Thymol violet, Brilliant yellow, Ethyl orange, p-Xylenol, Metanil yellow, 2,5-dinitrophenol, or 4-nitrophenol.

7. The indicating adsorbent composition of claim 1, wherein the impregnated adsorbent component is present in about 75% to 98% by weight and the reactive indicator is present in about 2% to 25% by weight.

8. The indicating adsorbent composition of claim 1, wherein the impregnated adsorbent component is present in about 98% to 99% by weight and the reactive indicator is present in about 1% to 2% by weight.

9. The indicating adsorbent composition of claim 1, wherein the impregnated adsorbent component is present in about 99% to 99.9% by weight and the reactive indicator is present in about 0.1% to 1% by weight.

10. A method of purifying contaminated air comprising contacting the contaminated air with an indicating adsorbent composition comprising an adsorbent, an impregnate, and a reactive indicator, wherein the reactive indicator is a pH indicator.

11. A method for determining the remaining life of an indicating adsorbent composition, comprising visually inspecting the indicating adsorbent composition and comparing the color of the indicating adsorbent composition to a color chart which indicates the pH of the indicating adsorbent composition and is calibrated to show remaining service life of the indicating adsorbent composition.

12. A kit to determine service life of an indicating absorbent composition, comprising:
an indicating adsorbent composition, and a colorimetric calibration guide;
wherein the colorimetric calibration guide provides a schematic means to evaluate the remaining service life of the indicating absorbent composition.
